(19) United States
(12) Patent Application Publication
(10) Pub. No.: US 2003/0235756 A1
(43) Pub. Date: Dec. 25, 2003

(54) Lithium cell process with layer tacking

(76) Inventors: Charles T. McCarley, Noblesville, IN (US); Gregory K. MacLean, Indianapolis, IN (US)

Correspondence Address: MARGARET A. DOBROWITSKY, DELPHI TECHNOLOGIES, INC., P.O. Box 5052, Mail Code: 480-414-420, Troy, MI, 48007-5052, US

(21) Appl. No.: 10/177,183

(22) Filed: Jun. 21, 2002

(51) Int. Cl. H01M 2/08

(52) U.S. Cl. 429/185; 29/623.2; 29/623.4

(57) ABSTRACT

A lithium cell having an electrochemically inert tacking material between and/or on an edge of cell layers for intimate contact of the layers during and after assembly, and a method of making a lithium cell. The tacking material replaces the use of a plasticizer within the active material to achieve this contact, thereby eliminating the associated cost and time involved in removing the plasticizer. The invention facilitates ease of handling the cell during subsequent processing and prevents misalignment of the cell layers during subsequent process steps. The resulting assembly results in optimum ion transfer and battery performance.

### FIELD OF THE INVENTION

This invention relates to a method of preparation of lithium cells, in particular lithium ion and lithium ion polymer batteries.

### BACKGROUND OF THE INVENTION

Lithium ion cells and batteries are secondary (i.e., rechargeable) energy storage devices well known in the art. The lithium ion cell, known also as a rocking chair type lithium ion battery, typically comprises essentially a carbonaceous anode (negative electrode) that is capable of intercalating lithium ions, a lithium-retentive cathode (positive electrode) that is also capable of intercalating lithium ions, and a non-aqueous, lithium ion conducting electrolyte therebetween.

The carbon anode comprises any of the various types of carbon (e.g., graphite, coke, carbon fiber, etc,) which are capable of reversibly storing lithium species, and which are bonded to an electrochemically conductive current collector (e.g. copper foil) by means of a suitable organic binder (e.g., polyvinylidene fluoride, PVdF).

The cathode comprises such materials as transition metal chalcogenides that are bonded to an electrochemically conductive current collector (e.g., aluminum foil) by a suitable organic binder. Chalcogenide compounds include oxides, sulfides, selenides, and tellurides of such metals as vanadium, titanium, chromium, copper, molybdenum, niobium, iron, nickel, cobalt and manganese. Lithiated transition metal oxides are at present the preferred positive electrode intercalation compounds. Examples of suitable cathode materials include LiMnO₂, LiCoO₂, LiNiO₂, and LiFePO4, their solid solutions and/or their combination with other metal oxides and dopant elements, e.g., titanium, magnesium, aluminum, boron, etc.

The electrolyte in such lithium ion cells comprises a lithium salt dissolved in a non-aqueous solvent which may be (1) completely liquid, (2) an immobilized liquid (e.g., gelled or entrapped in a polymer matrix), or (3) a pure polymer. Known polymer matrices for entrapping the electrolyte include polyacrylates, polyurethanes, polydialkylsiloxanes, polymethacrylates, polyphosphazenes, polyethers, polyvinylidene fluoride, polyolefins such as polypropylene and polyethylene, and polycarbonates, and may be polymerized in situ in the presence of the electrolyte to trap the electrolyte therein as the polymerization occurs. Known polymers for pure polymer electrolyte systems include polyethylene oxide (PEO), polymethylene-polyethylene oxide (MPEO), or polyphosphazenes (PPE). Known lithium salts for this purpose include, for example, LiPF₆, LiClO₄, LiSCN, LiAlCl₄, LiBF₄, LiN(CF₃SO₂)₂, LiCF₃SO₃, LiC(SO₂CF₃)₃, LiO₃SCF₂CF₃, LiC₆F₅SO₃, LiO₂CF₃, LiAsF₆, and LiSbF₆. Known organic solvents for the lithium salts include, for example, alkylcarbonates (e.g., propylene carbonate, ethylene carbonate), dialkyl carbonates, cyclic ethers, cyclic esters, glymes, lactones, formates, esters, sulfones, nitrites, and oxazolidinones. The electrolyte is incorporated into pores in a separator layer between the cathode and anode. The separator may be glass mat, for example, containing a small percentage of a polymeric material, or may be any other suitable ceramic or ceramic/polymer material. Silica is a typical main component of the separator layer.

Lithium and lithium ion polymer cells are often made by adhering, e.g., by laminating, thin films of the anode, cathode and/or electrolyte/separator together. The electrolyte/separator is adhered to an electrode (anode or cathode) to form a subassembly, or is adheringly sandwiched between the anode and cathode layers to form an individual cell or unicell. A second electrolyte/separator and a second corresponding electrode may be adhered to form a bicell. A plurality of cells are adhered and bundled together to form a high energy/voltage battery or multicell.

Intimate contact between layers of a cell is required for optimum ion transfer and cell performance. Current processes use heat and pressure lamination to achieve contact of the multiple layers of a cell, including current collectors carrying films of active material and the separator layer. This type of lamination requires that the active material contain plasticizers, which must later be removed. Removal of plasticizers involves a separate process, which adds to both the time and cost involved in cell assembly.

There is thus a need to develop methods to assemble and produce a lithium cell having intimate contact between cell layers without the use of plasticizers, which require removal, to achieve this contact.

### SUMMARY OF THE INVENTION

The present invention provides a method of tacking layers of a lithium cell to ensure proper alignment and adhesion during subsequent processing, and optimum ion transfer and performance upon assembly. An electrochemically inert tacking material is provided to at least one contacting surface of a first cell component or layer (e.g., anode), and then contacting the first cell layer with a second cell component or layer (e.g., separator) to adhere the first and second components or layers. The tacking material may be provided to both contacting surfaces (e.g., anode and separator). The tacking material may also be provided to additional cell components or layers to form unicell, bicell, or multicell assemblies.

Presently used methods adhere components using plasticizers, which require separate removal steps. The inventive method desirably eliminates these additional steps and provides adherent subassemblies or assemblies that can be manipulated, processed, transported, etc. without misalignment. The electrochemically inert tacking materials include polymer softening agents, thermoplastics, and/or adhesives.

The present invention further provides a lithium cell in which the layers are adhered by the electrochemically inert tacking material.

There is thus provided a lithium cell and method of manufacturing that addresses the problems of achieving intimate contact between the layers of a cell to reproducibly obtain optimum performance.

### DETAILED DESCRIPTION OF THE INVENTION

The present invention provides a method to obtain contact between components or layers of a cell during and after assembly. The present invention also provides a cell produced by the inventive method. The method eliminates the use of a plasticizer within the active material to achieve this contact, which desirably eliminates the associated cost and time involved in removing the plasticizer.

To this end, and in accordance with the present invention, an electrochemically inert tacking material is provided on one or more cell components to achieve intimate contact with a contacting component, resulting in the formation of a cell subassembly and/or assembly. The component may be an anode, a cathode, and/or a separator. The resulting assembly may be a unicell, a bicell, or a multicell. The resulting assembly may be a battery, such as a lithium ion polymer battery.

The tacking material is of a quality and quantity sufficient to adhere the layers so as to form a discrete component. Besides advantageously reducing the concomitant cost and time involved in cell assembly, the invention facilitates ease of handling the cell during subsequent processing. The subassembly or assembly may be transported, evaluated, manipulated, further processed, etc., using routine manual or automated procedures. The invention also prevents misalignment of the cell layers during subsequent process steps, ensuring quality of the resulting product from the final adhesion and/or packaging.

The tacking material may be any material that is electrochemically inert. Exemplary materials include, but are not limited to, one or more of polymer softening agents, for example, organic carbonates such as propylene carbonate, phthalic acid diesters, adipic acid diesters, acetic acid esters, organic phosphates, and/or trimellitic acid triesters; thermoplastics, for example, polyolefins such as polyethylene, polypropylene, etc., polyacrylic acid modified polyolefins, polyacrylic acid esters, polyacetates, cellulose acetate and butyrate, nylons, polycarbonates, polyterephthalates, polystyrenes, polyacrylonitriles, polytetrafluoroethylene, polyfluorochloroethylenes, polyvinylchloride, polyvinylidene fluoride, polyvinylidene fluoride chloride, polyvinylidene chloride, and/or polyvinylchloride acetate; and adhesives, for example, rubbers such as gums, latex, styrene-butadiene, acrylonitrile-butadiene or ethylene propylene diene monomers (EPDM), silicones, cyanoacrylic acid esters, and/or epoxies.

The tacking material may be applied neat in a natural form, or may be applied as a solution, e.g., using a fast-drying solvent. Any tacking material that is unreactive with the polymer binder, in that it does not contain one or more components capable of dissolving the polymer binder in the active material, may be employed.

In one embodiment, the tacking material is applied to either or both face of the contacting surface(s) of the specific components to be adhered. In another embodiment, the tacking material is applied to one or more edges of the surface(s) to be adhered. In yet another embodiment, the tacking material is applied to both a face surface and an edge surface of one or more components to be adhered. It is applied in a minimal quantity that is sufficient to adhere the layers without affecting or interfering with the electrochemical functions of the cell. It may be applied to the entire surface or to any portion of the surface or surfaces sufficient to result in adhesion, for example, center, periphery, etc. If the tacking material is applied to an edge surface, it may be applied to one or more edges in its entirety or in part (for example, as a continuous or discontinuous strip, as dots, etc.) As used herein, the term Asurface@ encompasses a face surface, an edge surface, and a face and edge surface.

In one embodiment, a cell has a first anode cell layer, a second separator cell layer, and a third cathode cell layer, with the separator cell layer sandwiched between the first and third cell layers, and with the electrochemically inert tacking material provided to the separator layer on both of its surfaces; that is, on its first cell layer-contacting surface and on its third cell layer-contacting surface. It will be appreciated by one skilled in the art that the first cell layer can also be identified as a cathode cell layer, with the third cell layer then being an anode cell layer.

In another embodiment, a cell has a first anode cell layer, a second separator cell layer, and a third cathode cell, with the separator cell layer sandwiched between the first and third cell layers, and with the electrochemically inert tacking material provided to the anode on its separator cell layer-contacting surface, and provided to the cathode on its separator cell layer-contacting surface. It will be appreciated by one skilled in the art that the first cell layer can also be identified as a cathode cell layer, with the third cell layer then being an anode cell layer.

In another embodiment, a cell has a first anode cell layer, a second separator cell layer, and a third cathode cell layer, with the separator cell layer sandwiched between the first and third cells layers, and with the electrochemically inert tacking material provided to the separator cell layer-contacting surface of the anode cell layer, the anode cell layer-contacting surface of the separator cell layer, and either or both of the separator cell layer-contacting surface of the cathode cell layer and the cathode cell layer-contacting surface of the separator cell layer. It will be appreciated by one skilled in the art that the first cell layer can also be identified as a cathode cell layer, with the third cell layer then being an anode cell layer.

In another embodiment, a cell has a first anode cell layer, a second separator cell layer, and a third cathode cell layer, with the separator cell layer sandwiched between the first and third cell layers, and with the electrochemically inert tacking material provided to the separator cell layer-contacting surface of the cathode cell layer, the cathode cell layer-contacting surface of the separator cell layer, and either or both of the separator cell layer-contacting surface of the anode cell layer and the anode cell layer-contacting surface of the separator cell layer. It will be appreciated by one skilled in the art that the first cell layer can also be identified as a cathode cell layer, with the third cell layer then being an anode cell layer.

In another embodiment, a cell has a first anode cell layer, a second separator cell layer, and a third cathode cell layer, with the separator cell layer sandwiched between the first and third cell layers, and with the electrochemically inert tacking material provided to the separator cell layer-contacting surface of the anode cell layer, the anode cell layer-contacting surface of the separator cell layer, the separator cell layer-contacting surface of the cathode cell layer, and the cathode cell layer-contacting surface of the separator cell layer. It will be appreciated by one skilled in the art that the first cell layer can also be identified as a cathode cell layer, with the third cell layer then being an anode cell layer.

A lithium cell is prepared by providing a separator cell layer between an anode cell layer and a cathode cell layer, the anode and cathode having face and edge surfaces that contact the separator cell layer, and providing an electrochemically inert tacking material as previously described. Beneficially, the anode cell layer and the cathode cell layer contain an active material that is substantially free of a plasticizer. An electrochemically inert tacking material is provided to at least two of the contacting surfaces to form a subassembly, with the proviso that if the electrochemically inert tacking material is provided to only two contacting surfaces, these two contacting surfaces do not directly contact each other. That is, the abutting or directly-contacting surfaces do not each contain the electrochemically inert tacking material; if that were the case, then either the anode cell layer or the cathode cell layer would not adhere since it would lack the tacking material, while the other of the anode cell layer or the cathode cell layer would contain tacking material on both its separator cell layer-contacting surface as well as the anode- or cathode-cell layer contacting surface of the separator layer. If more than two surfaces are provided with the electrochemically inert tacking material, the three cell layers adhere.

The electrochemically inert tacking material adheres the layers to permit handling during subsequent processing to form a lithium cell. Adhesion may be achieved by pressing the contacting surfaces containing the electrochemically inert tacking material sufficient to adhere the anode cell layer and the cathode cell layer to the separator cell layer. This may be accomplished by pressure exerted by a manual or mechanical source, by heat, or by heat and pressure. The exact temperature depends upon the solvent composition, with an upper temperature limit set by the melting point of the electrode binder materials and/or separator materials. As used herein, Amelting point@ also refers to a softening point to describe a temperature for materials which soften, rather than melt, upon the application of heat. Once the cell layers have adhered, the adherent subassembly or assembly is then subsequently processed.

The tacking material may be applied by any technique including, but not limited to, direct contact, indirect contact (e.g., application to a surface other than the surface to be adhered, such as a roller or a film), spraying (aerosol or non-aerosol), brushing, spot-applying, strip-applying, etc., as known to one skilled in the art. The tacking material may be applied in any location, quantity, or configuration that will result in adherence of the desired surfaces. In various embodiments, the tacking material may be applied to either or both of the two contacting face or edge surfaces, and may be applied as discrete spots or continuous strips, and in any of random, intermittent, patterned, or defined locations on the desired surface(s).

Tacking assists in assuring initial and maintained adherence of the components in forming the subassembly, and/or adherence of the subassemblies in forming the assembly. In one embodiment, the tacking material is provided to the desired surface or surfaces of the component to be adhered as that component enters the cell assembly process. In an alternative process, the tacking material is applied to the desired face and/or edge surface or surfaces of the component to be adhered in a prior processing step, which may be advantageous for reasons such as processing efficiency, convenience, etc.

While the present invention has been illustrated by the description of embodiments thereof, and while the embodiments have been described in considerable detail, it is not intended to restrict or in any way limit the scope of the appended claims to such detail. Additional advantages and modifications will readily appear to those skilled in the art. For example, electrochemically inert tacking materials other than those specifically listed may be used. The invention in its broader aspects is therefore not limited to the specific details and representative method described. Accordingly, departures may be made from such details without departing from the scope or spirit of applicant=s general inventive concept.

What is claimed is:

1. A method of tacking layers of a lithium cell comprising providing an electrochemically inert tacking material to at least one contacting surface of a first cell layer and thereafter contacting the first cell layer with a second cell layer to tack the first and second layers.

2. The method of claim 1, wherein the electrochemically inert tacking material is further provided to a contacting surface of the second cell layer.

3. The method of claim 1, wherein the electrochemically inert tacking material is selected from the group consisting a polymer softening agent, a thermoplastic, an adhesive, and combinations thereof.

4. The method of claim 1, wherein the electrochemic ally inert tacking material is a polymer softening agent selected from the group consisting of propylene carbonate, phthalic acid diesters, adipic acid diesters, acetic acid esters, organic phosphates, trimellitic acid triesters, and combinations thereof.

5. The method of claim 1, wherein the electrochemically inert tacking material is a thermoplastic selected from the group consisting of polyolefins, polyacrylic acid modified polyolefins, polyacrylic acid esters, polyacetates, cellulose acetate, cellulose butyrate, nylons, polycarbonates, polyterephthalates, polystyr enes, polyacrylonitriles, polytetrafluoroethylene, polyfluorochloroethylenes, polyvinylchloride, polyvinylidene fluoride, polyvinylidene fluoride chloride, polyvinylidene chloride, polyvinylchloride acetate, and combinations thereof.

6. The method of claim 1, wherein the electrochemically inert tacking material is an adhesive selected from the group consisting of a rubber, a silicone, a cyanoacrylic acid ester, an epoxy, and combinations thereof.

7. The method of claim 6, wherein the adhesive is a rubber selected from the group consisting of gums, latex, styrene-butadiene, acrylonitrile-butadiene, ethylene propylene diene monomers (EPDM), silicones, and combinations thereof.

8. The method of claim 1, wherein the tacking material is applied neat.

9. The method of claim 1, wherein the tacking material is applied as a solution.

10. The method of claim 1, wherein the first cell layer is selected from the group consisting of an anode and a cathode, and the second cell layer is a separator.

11. The method of claim 1, wherein the first cell layer is a separator, and the second cell layer is selected from the group consisting of an anode and a cathode.

12. The method of claim 1, wherein the contacting surface is selected from the group consisting of a face contacting surface, an edge contacting surface, and combinations thereof.

13. A method of assembling a lithium cell comprising
providing a first cell component having a contacting surface for a second cell component,
providing an electrochemically inert tacking material to the contacting surface of the first cell component, and
providing the second cell component to adheringly contact the contacting surface of the first cell component.

14. The method of claim 13, further comprising providing an electrochemically inert tacking material to the second cell component.

15. The method of claim 13, further comprising performing the method to a plurality of cells to form a multicell.

16. The method of claim 13, wherein the electrochemically inert tacking material is provided directly to the contacting surface.

17. The method of claim 13, wherein the electrochemically inert tacking material is provided indirectly to the contacting surface.

18. The method of claim 13, wherein the electrochemic ally inert tacking material is provided by spraying the contacting surface.

19. The method of claim 13, wherein the contacting surface is selected from the group consisting of a face contacting surface, an edge contacting surface, and combinations thereof.

20. A method of preparing a lithium cell comprising
providing a first cell component having a contacting surface for a second cell component,
providing an electrochemically inert tacking material to the contacting surface of the first cell component to form a prepared cell component,
and providing the prepared cell component for subsequent processing.

21. The method of claim 20, wherein processing comprises adhering the second cell component to form a subassembly.

22. The method of claim 21, wherein processing comprises providing the tacking material to a third cell component and adhering the third cell component to the subassembly to form an assembly.

23. The method of claim 22, wherein processing comprises adhering a plurality of assemblies.

24. The method of claim 21, wherein the subassembly has a first cell layer selected from the group consisting of an anode and a cathode, a second separator cel layer, and a third cell layer selected from the group consisting of an anode and a cathode, with the proviso that the third cell layer is different from the first cell layer, the separator cell layer having a first cell layer-contacting surface and a third cell layer-contacting surface, wherein the electrochemically inert tacking material is provided to the separator layer on the first cell layer-contacting surface of the separator layer and the third cell layer-contacting surface of the separator layer.

25. The method of claim 21, wherein adhering is by a method selected from the group consisting of pressure, and heat and pressure.

26. The method of claim 22, wherein adhering is by a method selected from the group consisting of pressure, and heat and pressure.

27. The method of claim 22, wherein the assembly has a first cell layer selected from the group consisting of an anode and a cathode, a second separator cell layer, and a third cell layer selected from the group consisting of an anode and a cathode, with the proviso that the third cell layer is different from the first cell layer, the first cel layer having a separator cell layer-contacting surface and the third cell layer having a separator cell layer-contacting surface, wherein the electrochemically inert tacking material is provided to the separator cell layer-contacting surface of the first cell layer and the separator cell layer-contacting surface of the third cell layer.

28. The method of claim 22, wherein the assembly has a first cell layer selected from the group consisting of an anode and a cathode, a second separator cell layer, and a third cell layer selected from the group consisting of an anode and a cathode, with the proviso that the third cell layer is different from the first cell layer, the first cell layer having a separator cell layer-contacting surface and the third cell layer having a separator cell layer-contacting surface, wherein the electrochemically inert tacking material is provided to the separator cell layer-contacting surfaces of the first cell layer and the third cell layer, and to at least one of the first cell layer-contacting surface and the third cell layer contacting surface of the separator cell layer.

29. The method of claim 20, wherein the contacting surface is selected from the group consisting of a face containing surface, an edge containing surface, and combinations thereof.

30. A method of preparing a lithium cell comprising
providing an anode having a separator-contacting surface;
providing a cathode having a separator-contacting surface;
providing a separator having first and second contacting surfaces, the first contacting surface adapted to contact the anode-contacting surface and the second contacting surface adapted to contact the cathode-contacting surface; and
providing an electrochemically inert tacking material to at least two of the contacting surfaces to form an assembly, with the proviso that if the electrochemically inert tacking material is provided to only two contacting surfaces, the two contacting surfaces do not directly contact each other.

31. The method of claim 30, further comprising providing the assembly for subsequent processing.

32. The method of claim 30, further comprising forming the assembly by a method selected from the group consisting of pressing, and heating and pressing, the contacting surfaces containing the electrochemically inert tacking material sufficient to adhere the anode and the cathode to the separator.

33. The method of claim 30, wherein the electrochemically inert tacking material is provided to at least the anode separator-contacting surface and the cathode separator-contacting surface.

34. The method of claim 30, wherein the electrochemically inert tacking material is provided to at least the anode-contacting surface and the cathode-contacting surface of the separator.

35. The method of claim 30, wherein the contacting surface is selected from the group consisting of a face contacting surface, an edge contacting surface, and combinations thereof.

36. A lithium cell comprising
a first cell layer having a contacting surface for a second cell layer,
a second cell layer having a contacting and a non-contacting surface for the first cell layer, and
an electrochemically inert tacking material provided to at least one contacting surface to adheringly contact the first and second cell layers.

37. The cell of claim 36, further comprising a third cell layer having a contacting surface for the second cell layer, an electrochemically inert tacking material provided to at least one of
the second cell layer-non-contacting surfaces for the first layer, and
the third cell layer-contacting surface for the second cell layer.

38. The cell of claim 36, wherein the electrochemically inert tacking material is selected from the group consisting a polymer softening agent, a thermoplastic, an adhesive, and combinations thereof.

39. The cell of claim 36, wherein the electrochemically inert tacking material is a polymer softening agent selected from the group consisting of propylene carbonate, phthalic acid diesters, adipic acid diesters, acetic acid esters, organic phosphates, trimellitic acid triesters, and combinations thereof.

40. The cell of claim 36, wherein the electrochemically inert tacking material is a thermoplastic selected from the group consisting of polyolefins, polyacrylic acid modified polyolefins, polyacrylic acid esters, polyacetates, cellulose acetate, cellulose butyrate, nylons, polycarbonates, polyterephthalates, polystyrenes, polyacrylonittiles, polytetrafluoroethylene, polyfluorochloroethylenes, polyvinylchloride, polyvinylidene fluoride, polyvinylidene fluoride chloride, polyvinylidene chloride, polyvinylchloride acetate, and combinations thereof.

41. The cell of claim 36, wherein the electrochemically inert tacking material is an adhesive selected from the group consisting of a rubber, a silicone, a cyanoacrylic acid ester, an epoxy, and combinations thereof.

42. The cell of claim 36, wherein the adhesive is a rubber selected from the group consisting of gums, latex, styrene-butadiene, acrylonitrile-butadiene, ethylene propylene diene monomers (EPDM), silicones, and combinations thereof.

43. The cell of claim 36, wherein the first cell layer is selected from the group consisting of an anode and a cathode, and the second cell layer is a separator.

44. The cell of claim 36, wherein the first cell layer is a separator, and the second cell layer is selected from the group consisting of an anode and a cathode.

45. The cell of claim 36, wherein the contacting surface is selected from the group consisting of a face contacting surface, an edge contacting surface, and combinations thereof.

46. A lithium cell comprising an anode layer and a cathode layer each adhered to a separator layer therebetween, and an electrochemically inert tacking material between the anode layer and the separator layer, and an electrochemically inert tacking material between the cathode layer and the separator layer.

47. The lithium cell of claim 46, wherein the anode layer and the cathode layer contain an active material that is substantially free of a plasticizer.

48. The lithium cell of claim 46, wherein the electrochemic ally inert tacking material is unreactive with the anode layer and the cathode layer.

49. The lithium cell of claim 46, wherein the electrochemically inert tacking material between the anode layer and the separator layer, and between the cathode layer and the separator layer is the same.

50. The lithium cell of claim 46, wherein the electrochemically inert tacking material between the anode layer and the separator layer, and between the cathode layer and the separator layer is different.
